(19) United States
(12) Patent Application Publication
(10) Pub. No.: US 2024/0239344 A1
(43) Pub. Date: Jul. 18, 2024

(54) VEHICLE CONTROL APPARATUS

(71) Applicants: DENSO CORPORATION, Kariya-city (JP); TOYOTA JIDOSHA KABUSHIKI KAISHA, Toyota-shi (JP)

(72) Inventors: Ryotaro ARAKI, Tokyo (JP); Yohei MASUI, Tokyo (JP); Tomohiko INOUE, Tokyo (JP); Yuki YAMAGUCHI, Toyota-shi, Aichi-ken (JP); Naoki KUSUMOTO, Okazaki-shi, Aichi-ken (JP)

(21) Appl. No.: 18/620,707

(22) Filed: Mar. 28, 2024

Related U.S. Application Data
(63) Continuation of application No. PCT/JP22/35502, filed on Sep. 22, 2022.

(30) Foreign Application Priority Data
Sep. 30, 2021 (JP) 2021-162057

(51) Int. Cl. B60W 30/165

(52) U.S. Cl. CPC B60W 30/165

(57) ABSTRACT

When determining that, with an adjacent preceding vehicle selected as a tracking-control target, (i) an operated acceleration request for an own vehicle has been inputted to a vehicle control apparatus and (ii) the adjacent preceding vehicle is likely to be changed as an own-lane preceding vehicle, the vehicle control apparatus performs tracking control of the own vehicle with respect to the adjacent preceding vehicle. When determining that, with the adjacent preceding vehicle selected as the tracking-control target, (i) the operated acceleration request for the own vehicle has been inputted to the vehicle control apparatus and (ii) the adjacent preceding vehicle is unlikely to be changed as an own-lane preceding vehicle, the vehicle control apparatus terminates the tracking control of the own vehicle.

### CROSS REFERENCE TO RELATED APPLICATION

This application is a bypass continuation application of currently pending international application No. PCT/JP2022/035502 filed on Sep. 22, 2022 designating the United States of America, the entire disclosure of which is incorporated herein by reference, the international application being based on and claiming the benefit of priority from Japanese Patent Application No. 2021-162057 filed on Sep. 30, 2021, the disclosure of which is incorporated in its entirety herein by reference.

### TECHNICAL FIELD

The present disclosure relates to vehicle control apparatuses for assisting acceleration and/or deceleration of an own vehicle.

### BACKGROUND

A typical one of known vehicle control technologies performs assistance of acceleration/deceleration control of an own vehicle to accordingly cause the own vehicle to track a preceding vehicle as a control target. Japanese Patent Application Publication No. 2021-79942 discloses a technology that adjusts a distance between an own vehicle and a target ahead of the own vehicle and/or a braking operation of the own vehicle depending on a driver's accelerator-pedal value of the own vehicle. For example, when starting the braking operation to perform tracking control of causing the own vehicle to track the target vehicle, which has changed to a deceleration lane to decelerate, the disclosed technology aborts the braking operation in response to the driver's depression of the accelerator pedal, thus intermitting the tracking control of the own vehicle. This enables the own vehicle to pass the preceding vehicle.

### SUMMARY

The technology disclosed in the patent publication may intermit the tracking control of the own vehicle in response to the driver's depression of the accelerator pedal in a case where the own vehicle traveling in an own lane makes a lane change to travel behind the target vehicle that is traveling in a lane adjacent to the own lane. This may result in the own vehicle approaching the target vehicle.

Additionally, let us assume that the target vehicle and one or more other vehicles ahead of the target vehicle are traveling in a line on the lane adjacent to the own lane. In this assumption, because the own vehicle can track one of the other vehicles ahead of the target vehicle, the driver may repeat an accelerator-pedal operation to pass the line of the vehicles.

From this viewpoint, the present disclosure seeks to provide vehicle control apparatuses that perform assistance of acceleration/deceleration control of an own vehicle traveling an own lane, each of which is capable of enabling the own vehicle to smoothly pass one or more preceding vehicles traveling in a lane adjacent to the own lane.

The present disclosure provides first and second vehicle control apparatuses for performing acceleration/deceleration assistance for an own vehicle traveling in an own lane to accordingly perform tracking control that causes the own vehicle to track a preceding vehicle detected in front of the own vehicle or detected to a front left side or front right side of the own vehicle.

The first vehicle control apparatus includes a travel-control target selector configured to select a tracking-control target that is a target of the tracking control. The first vehicle control apparatus includes a preceding-vehicle change determiner. The preceding-vehicle change determiner is configured to determine whether the tracking-control target is an adjacent preceding vehicle that is traveling ahead of the own vehicle in a lane adjacent to the own lane of the own vehicle. The preceding-vehicle change determiner is configured to determine, in response to determination that the tracking-control target is the adjacent preceding vehicle that is traveling ahead of the own vehicle in the adjacent lane, whether the adjacent preceding vehicle is likely to be changed as an own-lane preceding vehicle that will travel ahead of the own vehicle in the own lane. The first vehicle control apparatus includes an instruction determiner. The instruction determiner is configured to calculate a target level of acceleration/deceleration of the own vehicle in accordance with determination of whether to perform the tracking control of the own vehicle with respect to the tracking-control target. The instruction determiner is configured to determine, based on the calculated target level acceleration/deceleration of the own vehicle, one or more control instructions for the own vehicle. When determining that, with the adjacent preceding vehicle selected as the tracking-control target, (i) an operated acceleration request for the own vehicle has been inputted to the vehicle control apparatus and (ii) the adjacent preceding vehicle is likely to be changed as an own-lane preceding vehicle, the first vehicle control apparatus is configured to perform the tracking control of the own vehicle with respect to the adjacent preceding vehicle. When determining that, with the adjacent preceding vehicle selected as the tracking-control target, (i) the operated acceleration request for the own vehicle has been inputted to the vehicle control apparatus and (ii) the adjacent preceding vehicle is unlikely to be changed as an own-lane preceding vehicle, the first vehicle control apparatus is configured to terminate the tracking control of the own vehicle.

In the first vehicle control apparatus, the preceding-vehicle change determiner determines, in response to determination that the tracking-control target is the adjacent preceding vehicle that is traveling ahead of the own vehicle in the adjacent lane, whether the adjacent preceding vehicle is likely to be changed as an own-lane preceding vehicle that will travel ahead of the own vehicle in the own lane. When determining that, with the adjacent preceding vehicle selected as the tracking-control target, (i) an operated acceleration request for the own vehicle has been inputted to the vehicle control apparatus and (ii) the adjacent preceding vehicle is likely to be changed as an own-lane preceding vehicle, the first vehicle control apparatus performs the tracking control of the own vehicle with respect to the adjacent preceding vehicle. This prevents the own vehicle from approaching the own-lane preceding vehicle excessively closely, making it possible to reliably ensure the safety of the own vehicle and the own-lane preceding vehicle.

When determining that, with the adjacent preceding vehicle selected as the tracking-control target, (i) the operated acceleration request for the own vehicle has been inputted to the vehicle control apparatus and (ii) the adjacent preceding vehicle is unlikely to be changed as an own-lane preceding vehicle, the first vehicle control apparatus terminates the tracking control of the own vehicle. This enables the own vehicle to pass the adjacent preceding vehicle smoothly.

The second vehicle control apparatus includes a travel-control target selector configured to select a tracking-control target that is a target of the tracking control, a tracking prohibition determiner, and an instruction determiner. The travel-control target selector is configured to select a tracking-control target that is a target of the tracking control. The tracking prohibition determiner is configured to terminate, when determining that an operated acceleration request for the own vehicle has been inputted to the vehicle control apparatus with the adjacent preceding vehicle selected as the tracking-control target, the tracking control of the own vehicle with respect to the adjacent preceding vehicle. The tracking prohibition determiner is configured to determine whether a predetermined first period has elapsed since the own vehicle passed the adjacent preceding vehicle, and prohibit the tracking control of the own vehicle with respect to any vehicle traveling in the adjacent lane until it is determined that the predetermined first period has elapsed since the own vehicle passed the adjacent preceding vehicle. The instruction determiner is configured to calculate a target level of acceleration/deceleration of the own vehicle in accordance with determination of whether to perform the tracking control of the own vehicle with respect to the tracking-control target. The instruction determiner is configured to determine, based on the calculated target level acceleration/deceleration of the own vehicle, one or more control instructions for the own vehicle.

In the second vehicle control apparatus, the tracking prohibition determiner terminates, when determining that an operated acceleration request for the own vehicle has been inputted to the vehicle control apparatus with the adjacent preceding vehicle selected as the tracking-control target, the tracking control of the own vehicle with respect to the adjacent preceding vehicle. The tracking prohibition determiner determines whether the predetermined first period has elapsed since the own vehicle passed the adjacent preceding vehicle, and prohibits the tracking control of the own vehicle with respect to any vehicle traveling in the adjacent lane until it is determined that the predetermined first period has elapsed since the own vehicle passed the adjacent preceding vehicle.

Even if the adjacent preceding vehicle and one or more other vehicles ahead of the adjacent preceding vehicle are traveling in a line on the lane adjacent to the own lane, the tracking prohibition determiner prohibits the tracking control of the own vehicle with respect to the one or more other vehicles traveling ahead of the adjacent preceding vehicle in the adjacent lane until it is determined that the predetermined first period has elapsed since the own vehicle passed the adjacent preceding vehicle.

This avoids the own vehicle from tracking the one or more other vehicles traveling ahead of the adjacent preceding vehicle until the first period has elapsed since the own vehicle passed the adjacent preceding vehicle, making it possible to enable the own vehicle to pass the line of the adjacent preceding vehicle and the one or more other vehicles efficiently. That is, the second vehicle control apparatus makes it possible for the own vehicle to pass one or more vehicles traveling in the adjacent lane smoothly.

### BRIEF DESCRIPTION OF THE DRAWINGS

Other aspects of the present disclosure will become apparent from the following description of embodiments with reference to the accompanying drawings in which:

FIG. 1 is a block diagram of a vehicular system including a vehicle control apparatus according to the exemplary embodiment;

FIG. 2 is a flowchart illustrating a vehicle control routine to be carried out by the vehicle control apparatus;

FIGS. 3A to 3C are each a view illustrating an operation of determining whether an adjacent preceding vehicle has changed;

FIG. 4 is a view illustrating a traffic situation where an own vehicle has passed the adjacent preceding vehicle; and

FIGS. 5A and 5B are each a view illustrating a traffic situation where a predetermined period has elapsed since the own vehicle passed the adjacent preceding vehicle.

### DETAILED DESCRIPTION OF EMBODIMENT

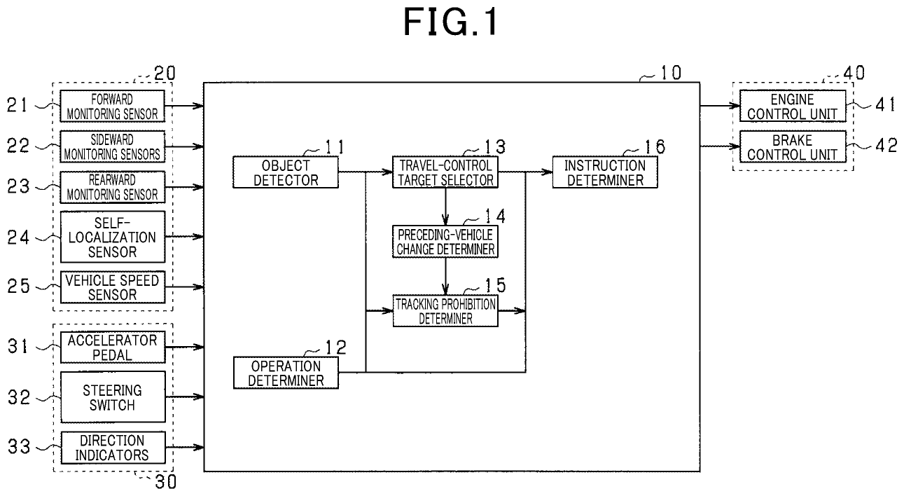

FIG. 1 illustrates a vehicular system including a vehicle control apparatus 10 according to an exemplary embodiment.

Specifically, the vehicular system includes the vehicle control apparatus 10, various types of sensors 20, operable input devices 30, and a control module 40.

The vehicle control apparatus 10, installed in an own vehicle, has an adaptive cruise control (ACC) function that adjusts driving power and/or braking power for the own vehicle to accordingly control a speed of the own vehicle, thus keeping a target safe distance from the own vehicle to a preceding vehicle.

The vehicle control apparatus 10 is configured to perform acceleration/deceleration assistance for the own vehicle to accordingly perform tracking control that causes the own vehicle to track a target preceding vehicle detected in front of the own vehicle or detected in the front left side or right side of the own vehicle.

The vehicle control apparatus 10 can serve as a pre-crash safety system (PCS) that determines whether the own vehicle will collide with one or more objects located around the own vehicle, and performs control of avoiding the own vehicle from colliding with the one or more objects and/or alleviating damage due to collision of the own vehicle with the one or more objects.

The vehicle control apparatus 10 can have a lane keeping assist (LKA) function of generating steering power directed to prevent the own vehicle from approaching lane markers to accordingly keep the own vehicle in a lane in which the own vehicle is traveling.

The vehicle control apparatus 10 can have a lane-change assist (LCA) function of automatically making a lane change from an own lane in which the own vehicle is traveling to a lane, i.e., an adjacent lane, adjacent to the own lane.

The various types of sensors 20 include a forward monitoring sensor 21, sideward monitoring sensors 22, a rearward monitoring sensor 23, a self-localization estimation sensor 24, and a vehicle speed sensor 25. Information detected by the sensors 20 to 25 are inputted to the vehicle control apparatus 10.

The forward monitoring sensor 21 is configured to monitor a forward view of the own vehicle, each of the sideward monitoring sensors 22 is configured to monitor a corresponding one of a left- or a right-sideward view of the own vehicle, and the rearward monitoring sensor 23 is configured to monitor a rearward view of the own vehicle.

Each sensor 21, 22, and 23 can be comprised of suitably selected at least one of an image sensor, a radio-wave radar, a laser radar, and an ultrasonic-wave sensor.

The image sensor is comprised of, for example, a CCD camera, a CMOS image sensor, or a near-infrared camera. The image sensor can be configured as a monocular camera or a stereo camera.

If the forward monitoring sensor 21 is comprised of a camera, i.e., a forward camera as such an image sensor, the forward camera is mounted to, for example, the center of the upper end of the front windshield of the own vehicle in the vehicle-width direction at a predetermined height. The forward camera is configured to capture images of a predetermined forward field of view of the own vehicle; the forward field of view has a predetermined angle of view.

If the rearward monitoring sensor 23 is comprised of a camera, i.e., a rearward camera as such an image sensor, the rearward camera is mounted to, for example, the center of the upper end of the rear windshield of the own vehicle in the vehicle-width direction at a predetermined height. The rearward camera is configured to capture images of a predetermined rearward field of view of the own vehicle; the rearward field of view has a predetermined angle of view.

If the sideward monitoring sensors are respectively comprised of cameras, such as first sideward and second sideward cameras as image sensors, the first sideward camera is mounted to, for example, a predetermined left-side portion of the body of the own vehicle; the predetermined left-side portion is for example adjacent to the left-side front door or the left-side rear door of the own vehicle. The first sideward camera is configured to capture images of a predetermined angular left-sideward field of view of the own vehicle; the left-sideward field of view has a predetermined angle of view. The second sideward camera is mounted to, for example, a predetermined right-side portion of the body of the own vehicle; the predetermined right-side portion is for example adjacent to the right-side front door or the right-side rear door of the own vehicle. The second sideward camera is configured to capture images of a predetermined angular right-sideward field of view of the own vehicle; the right-sideward field of view has a predetermined angle of view.

The radio-wave radar is configured to emit radio waves, and receive reflections based on the emitted radio waves to accordingly determine whether there is at least one object located around the own vehicle, and detect a distance of the at least one object located around the own vehicle from the own vehicle, and detect a position, a size, and a shape of the at least one object located around the own vehicle. Additionally, the radio-wave radar is configured to detect, based on the received reflections, a relative speed of the at least one object located around the own vehicle relative to the own vehicle.

The laser radar is configured to detect at least one object located around the own vehicle using infrared radar waves to accordingly detect, for example, a distance of the at least one object located around the own vehicle from the own vehicle, which is similar to the radio-wave radar. The ultrasonic sensor is configured to detect at least one object located around the own vehicle using ultrasonic waves to accordingly detect, for example, a distance of the at least one object located around the own vehicle from the own vehicle, which is similar to the radio-wave radar.

If each of the sensors 21, 22, and 23 is comprised of such a radar sensor, which is one of such a radio-wave radar, a laser radar, and an ultrasonic sensor, the radar sensors are mounted to the front end, rear end, left- and right-side ends of the body of the own vehicle, respectively. Each radar sensor is configured to scan a predetermined region around the own vehicle using a radar signal every predetermined time, so that the radar sensors scan the own vehicle's surroundings using their radar signals every predetermined time. Each radar sensor is additionally configured to receive echoes resulting from reflection of the scanned radar signals by the outer surface of at least one object located in the corresponding scanning region, so that the radar sensors detect, based on the received echoes, information on objects located around the own vehicle; the information on each object located around the own vehicle, which will also be referred to as object information, can include, for example, (i) a distance of the corresponding object relative to the own vehicle and (ii) a relative speed of the corresponding object relative to the own vehicle.

If a target preceding vehicle is traveling in front of the own vehicle, the radar sensors can detect information, i.e., preceding-vehicle information, on, for example, (i) a safe distance from the target preceding vehicle to the own vehicle, (ii) a relative speed of the target preceding vehicle relative to the own vehicle, and (iii) a relative acceleration of the target preceding vehicle relative to the own vehicle. The detected object information, i.e., the detected target preceding-vehicle information, is inputted to the vehicle control apparatus 10.

The self-localization sensor 24 can include one or more gyro sensors, or a global positioning system (GPS) sensor comprised of at least one GPS receiver. The at least one GPS receiver, which is an example of global navigation satellite system (GNSS) receivers, is configured to receive GPS signals, which are sent from a global positioning system (GPS) or a global navigation satellite system (GNSS), which determines the position of any point using satellites. Then, the at least one GPS receiver is configured to estimate, based on the GPS signals, a current location of the own vehicle, i.e., a current latitude and a current longitude of the own vehicle. The at least one GPS receiver can be configured to receive the GPS signals every predetermined period to accordingly estimate the current location of the own vehicle every predetermined period.

The current location of the own vehicle estimated by the self-localization sensor 24 is inputted to an unillustrated navigation system and/or an unillustrated radio communication device. The navigation system is configured to determine, based on a driver's inputted destination and the current location estimated by the GPS sensor, one or more scheduled routes for autonomous driving. The navigation system can be configured to determine or correct the one or more scheduled routes using, for example, the one or more gyro sensors in addition to the GPS sensor. The navigation system includes dynamic maps that include (i) static map information, such as information on road widths and lanes, and dynamic information, such as traffic-jam information. The radio communication device installed in the own vehicle is configured to perform (i) radio communications with intelligent transport systems, (ii) inter-vehicle communications with other vehicles, and (iii) road-to-vehicle communications with roadside units installed in road facilities. The above communications enable the own vehicle to send, to each other vehicle, conditions of the own vehicle and surrounding situations around the own vehicle, and receive, from each other vehicle, conditions of the corresponding other vehicle and surrounding situations around the corresponding other vehicle.

The vehicle speed sensor 25 is configured to measure the speed of the own vehicle. For example, the vehicle speed sensor can be comprised of wheel sensors, each of which measures the rotational speed of the corresponding one of the wheels of the own vehicle. Each wheel sensor can be mounted to the wheel body of the corresponding wheel, and is configured to output, to the vehicle control apparatus 10, a wheel-speed signal indicative of the speed of the corresponding wheel.

The operable input devices 30 include an accelerator pedal 31, a steering switch 32, and direction indicators 33. Driver's operations of each operable input device 30 enable information to be inputted to the corresponding operable input device 30, and the inputted information is inputted to the vehicle control apparatus 10.

When operated by the driver of the own vehicle, the accelerator pedal 31 inputs the driver's operated amount of the accelerator pedal 31 to the vehicle control apparatus 10. The steering switch 32 is mounted to the steering wheel of the own vehicle. When operated by the driver of the own vehicle, the steering switch 32 inputs information related to cruise control (CC) to the vehicle control apparatus 10. When operated by the driver of the own vehicle, each direction indicator 33 is configured to output, to the vehicle control apparatus 10, a corresponding one of left-turn and right-turn signals.

The vehicle control apparatus 10 includes an object detector 11, an operation determiner 12, a travel-control target selector 13, a preceding-vehicle change determiner 14, a tracking prohibition determiner 15, and an instruction determiner 16.

The vehicle control apparatus 10 includes an ECU that is comprised of one or more known microcomputers that include, for example, at least one CPU, at least one ROM, at least one RAM, and at least one flash memory.

The at least one CPU executes one or more computer programs installed in the at least one ROM to accordingly implement the above functions 11 to 16 included in the vehicle control apparatus 10. The vehicle control apparatus 10, which includes the above functions, is configured to output one or more control instructions to the control module 40 to accordingly perform drive assistances that include, for example, acceleration/deceleration assistances of the own vehicle, thus implementing the adaptive cruise control (ACC) of the own vehicle.

Additionally, during execution of the tracking control, the vehicle control apparatus 10 is configured to determine, when the own vehicle is about to change from an own lane of the own vehicle to an adjacent lane as a lane-change destination, which is adjacent to the own lane, whether there is an alternative preceding vehicle traveling in the adjacent lane in front of the own vehicle. Then, in response to determination that there is an alternative preceding vehicle traveling in the adjacent lane in front of the own vehicle, the vehicle control apparatus 10 is configured to continue, after change of the own lane to the adjacent lane, the tracking control using the alternative preceding vehicle as a new target preceding vehicle as the tracking target of the tracking control. In this case, the vehicle control apparatus 10 is configured to recognize a driver's lane-change command of the own vehicle based on the right-turn or left-turn signal from the corresponding direction indicator 33 to accordingly perform the switch from the present target preceding vehicle to the new target preceding vehicle for the tracking control. When changing the present own lane to an adjacent lane adjacent to the own lane, the vehicle control apparatus 10 is configured to adaptively decelerate the own vehicle to accordingly adjust a safe distance from the own vehicle to the new target preceding vehicle in the adjacent lane.

The object detector 11 is configured to detect, based on the object information acquired from the forward monitoring sensor 21, sideward monitoring sensors 22, and rearward monitoring sensor 23, at least one object located around the own vehicle.

For example, the object detector 11 calculates, based on the images captured by the image sensors, a distance of at least one image-based object, which is located around the own vehicle, relative to the own vehicle and an azimuth of the at least one image-based object relative to the own vehicle. Then, the object detector 11 for example calculates, based on the distance of the azimuth of the at least one image-based object, a relative position of the at least one image-based object relative to the own vehicle and an existence region of the at least one image-based object, thus acquiring the relative position and the existence region of the at least one image-based object as image information on the at least one image-based object.

Additionally, the object detector 11 calculates, based on the object information items detected by the radar sensors, a distance of at least one radar-based object, which is located around the own vehicle, relative to the own vehicle and an azimuth of the at least one radar-based object relative to the own vehicle. Then, the object detector 11 for example calculates, based on the distance of the azimuth of the at least one radar-based object, a relative position of the at least one radar-based object relative to the own vehicle and an existence region of the at least one radar-based object, thus acquiring the relative position and the existence region of the at least one radar-based object as radar information on the at least one radar-based object.

Then, the object detector 11 performs a fusion task of fusing the image information and the radar information to accordingly recognize at least one object. Specifically, the fusion task is configured to determine whether the existence region of the at least one image-based object at least partially overlap the existence region of the at least one radar-based object, and recognize at least one object that is commonly detected by the image sensors and the radar sensors upon determination that the existence region of the at least one image-based object at least partially overlap the existence region of the at least one radar-based object.

The object detector 11 can be configured to detect, for example, (i) moving objects around the own vehicle, such as other vehicles and/or pedestrians, (ii) carriageway markings, such as while lines, on road surfaces, (iii) information on red lights of traffic signals in intersections, (iv) traffic signs, such as pedestrian crossings and speed limits, and (v) various traffic signs on road surfaces. The object information on at least one object detected by the object detector 11 is inputted to the tracking-control target selector 13 and the tracking prohibition determiner 15.

The operation determiner 12 is configured to determine, based on the inputted information from the operable input devices 30, whether a predetermined operated request has been inputted to the vehicle control apparatus 10. For example, when determining that the driver's operated amount of the accelerator pedal 31 is greater than or equal to a predetermined threshold, the operation determiner 12 is configured to determine that an operated acceleration request for the own vehicle as the predetermined operated request has been inputted to the vehicle control apparatus 10. A result indicative of whether the predetermined entry has been inputted to the vehicle control apparatus 10 is inputted to the tracking-control target selector 13 and the tracking prohibition determiner 15.

The controlled target selector 13 is configured to select, from one or more preceding vehicles detected in front of the own vehicle or in the front left side or right side of the own vehicle, a tracking-control target that is a target of the tracking control of the own vehicle. For example, the tracking-control target selector 13 can select, from the object information inputted from the object detector 11, one or more preceding vehicles detected in front of the own vehicle or in the front left side or right side of the own vehicle. Then the tracking-control target selector 13 can recognize a driver's lane-change command of the own vehicle based on the right-turn or left-turn signal from the corresponding direction indicator 33 to accordingly select, from the one or more preceding vehicles, the tracking-control target that is the target of the tracking control of the own vehicle. Information indicative of the tracking-control target selected by the tracking-control target selector 13 is inputted to the preceding-vehicle change determiner 14 and the instruction determiner 16.

The preceding-vehicle change determiner 14 is configured to determine whether the tracking-control target is an adjacent preceding vehicle that is traveling ahead of the own vehicle in a lane adjacent to the own lane of the own vehicle, and determine, in response to determination that the tracking-control target is the adjacent preceding vehicle that is traveling ahead of the own vehicle in the adjacent lane, whether the adjacent preceding vehicle is likely to be changed as an own-lane preceding vehicle that will travel ahead of the own vehicle in the own lane.

For example, when determining that a lane change of the adjacent preceding vehicle from the adjacent lane to the own lane has been recognized and no driver's lane-change command of the own vehicle has been recognized, the preceding-vehicle change determiner 14 can determine that the adjacent preceding vehicle is likely to be changed as an own-lane preceding vehicle that will travel ahead of the own vehicle in the own lane.

As another example, when it is recognized that the own vehicle is intended to change the own lane to the adjacent lane so as to be located at the rear side of the adjacent preceding vehicle and no intention of lane change of the adjacent preceding vehicle has been recognized, the preceding-vehicle change determiner 14 can determine that the adjacent preceding vehicle is likely to be changed as an own-lane preceding vehicle that will travel ahead of the own vehicle in the own lane. The result of determination of whether the adjacent preceding vehicle is likely to be changed as an own-lane preceding vehicle that will travel ahead of the own vehicle in the own lane is inputted to the tracking prohibition determiner 15.

The tracking prohibition determiner 15 is configured to determine whether to prohibit the own vehicle from tracking the tracking-control target selected by the tracking-control target selector 13. Specifically, when determining that the operated acceleration request for the own vehicle has been inputted to the vehicle control apparatus 10 with the adjacent preceding vehicle selected as the tracking-control target, the tracking prohibition determiner 15 is configured to terminate the tracking control of the own vehicle with respect to the adjacent preceding vehicle. This determination enables the own vehicle to accelerate in the own lane independently of the speed of the adjacent preceding vehicle, making it possible for the own vehicle to pass the adjacent preceding vehicle.

Additionally, the tracking prohibition determiner 15 is configured to determine whether a predetermined first period has elapsed since the own vehicle passed the adjacent preceding vehicle, and prohibit the tracking control of the own vehicle with respect to any vehicle traveling in the adjacent lane until it is determined that the predetermined first period has elapsed since the own vehicle passed the adjacent preceding vehicle. This determination avoids the own vehicle from tracking one or more other vehicles traveling ahead of the adjacent preceding vehicle until it is determined that the first period has elapsed since the own-vehicle passed the adjacent preceding vehicle. This therefore prevents repeat of an accelerator-pedal operation for passing the line of the adjacent preceding vehicle and the one or more other vehicles in the adjacent lane, making it possible to enable the own vehicle to pass the line of the adjacent preceding vehicle and the one or more other vehicles efficiently.

Moreover, when determining that a forward adjacent preceding vehicle traveling ahead of adjacent preceding vehicle has been detected before lapse of the first period from when the own vehicle passes the adjacent preceding vehicle, the tracking prohibition determiner 15 is configured to continue prohibition of the tracking control of the own vehicle with respect to any vehicle traveling in the adjacent lane until it is determined that a predetermined second period has elapsed since the own vehicle passed the detected forward adjacent preceding vehicle. This determination enables the own vehicle to continue the state of efficiently passing the line of the adjacent preceding vehicle and the forward adjacent preceding vehicle traveling in the adjacent lane until the own vehicle passes the line of the adjacent preceding vehicle and the forward adjacent preceding vehicle without repeat of an accelerator-pedal operation. The second period can be set to be identical to or different from the first period.

The tracking prohibition determiner 15 can be configured to determine whether to cause the own vehicle to track the tracking-control target in accordance with information items inputted from the operation determiner 12, travel-control target selector 13, and preceding-vehicle change determiner 14.

For example, in response to determination that, with the adjacent preceding vehicle selected as the tracking-control target, (i) the operated acceleration request for the own vehicle has been inputted to the vehicle control apparatus 10 and (ii) the adjacent preceding vehicle is likely to be changed as an own-lane preceding vehicle, the tracking prohibition determiner 15 can be configured to determine to execute the tracking control of the own vehicle with respect to the adjacent preceding vehicle. As another example, in response to determination that, with the adjacent preceding vehicle selected as the tracking-control target, (i) the operated acceleration request for the own vehicle has been inputted to the vehicle control apparatus 10 and (ii) the adjacent preceding vehicle is unlikely to be changed as an own-lane preceding vehicle, the tracking prohibition determiner 15 can be configured to determine not to execute the tracking control of the own vehicle with respect to the adjacent preceding vehicle, i.e., determine to terminate the tracking control of the own vehicle.

The tracking prohibition determiner 15 is configured to generate, based on the result of determination of whether to prohibit the own vehicle from tracking the tracking-control target, at least one of (i) a prohibition instruction of prohibiting the tracking control, (ii) a cancellation instruction of cancelling the prohibition of the tracking control, (iii) an execution instruction indicative of execution of the tracking control, and (iv) a non-execution instruction of non-execution of the tracking control.

Then, the tracking prohibition determiner 15 is configured to output, to the instruction determiner 16, the at least one of the prohibition instruction, cancellation instruction, execution instruction, and non-execution instruction, so that the at least one of the prohibition instruction, cancellation instruction, execution instruction, and non-execution instruction is inputted to the instruction determiner 16.

The instruction determiner 16 can be configured to perform determination of whether to prohibit the own vehicle from tracking the tracking-control target in place of the tracking prohibition determiner 15.

The vehicle control apparatus 10 can be provided with a configuration independently from the above functions; the configuration performs determination of whether to prohibit the own vehicle from tracking the tracking-control target.

The instruction determiner 16 is configured to calculate a target level of acceleration/deceleration of the own vehicle in accordance with the at least one instruction that is sent from the tracking prohibition determiner 15 and represents information indicative of whether to execute the tracking control of the own vehicle with respect to the tracking-control target. The instruction determiner 16 is configured to determine, based on the calculated target level of acceleration/deceleration, the one or more control instructions.

For example, when receiving the execution instruction indicative of execution of the tracking control with no prohibition of the tracking control, the instruction determiner 16 calculates the target level of acceleration/deceleration for causing the own vehicle to track the tracking-control target. When receiving the execution instruction indicative of execution of the tracking control with prohibition of the tracking control, the instruction determiner 16 calculates the target level of acceleration/deceleration that is unsuitable for causing the own vehicle to track the tracking-control target. Similarly, when receiving the non-execution instruction indicative of non-execution of the tracking control with no prohibition of the tracking control, the instruction determiner 16 calculates the target level of acceleration/deceleration that is unsuitable for causing the own vehicle to track the tracking-control target.

The instruction determiner 16 determines, based on the calculated target level of acceleration/deceleration of the own vehicle, the one or more control instructions, and outputs the determined one or more control instructions to the control module 40.

The control module 40 includes an engine control unit 41 and a brake control unit 42.

The one or more control instructions, which are determined by the instruction determiner 16 for execution of the tracking control of the own vehicle with respect to the tracking-control target, instruct (i) the engine control unit 41 to control various actuators of the engine installed in the own vehicle and/or (ii) the brake control unit 42 to control the brake system installed in the own vehicle to accordingly cause the own vehicle to track the tracking-control target with a predetermined safe distance to the tracking-control target from the own vehicle. This therefore makes it possible to perform the adaptive cruise control of the own vehicle with respect to the tracking-control target. The control module 40 can include an unillustrated steering control unit for controlling the driver's steering, and/or an interface control unit for controlling human interfaces of the own vehicle.

The engine control unit 41 is configured to control the various actuators of the engine to accordingly control
1. An open or close operation of a throttle valve of the engine
2. An ignition operation by each igniter of the engine
3. An open or close operation of each intake valve of the engine

The brake system includes various sensors and actuators; these actuators include motors, valves, and pumps, which are used to control braking of the own vehicle. The brake control unit 42 is configured to control the brake system to accordingly
1. Determine a braking timing and a predetermined amount of braking
2. Control each of the actuators to thereby slow down the own vehicle based on the determined amount of braking at the determined braking timing

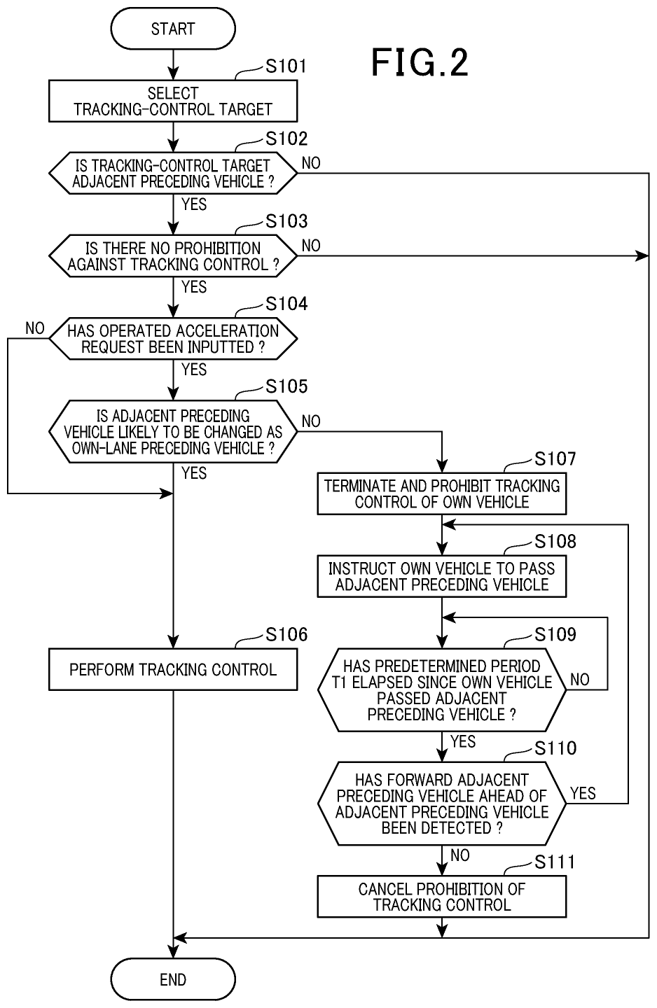

FIG. 2 is a flowchart illustrating a vehicle control routine to be carried out by the vehicle control apparatus 10. The vehicle control apparatus 10 is programmed to iterate the vehicle control routine illustrated in FIG. 2 every predetermined cycle.

In step S101, the vehicle control apparatus 10 selects, from one or more preceding vehicles detected in front of the own vehicle or in the front left side or right side of the own vehicle, a tracking-control target that is a target of the tracking control of the own vehicle.

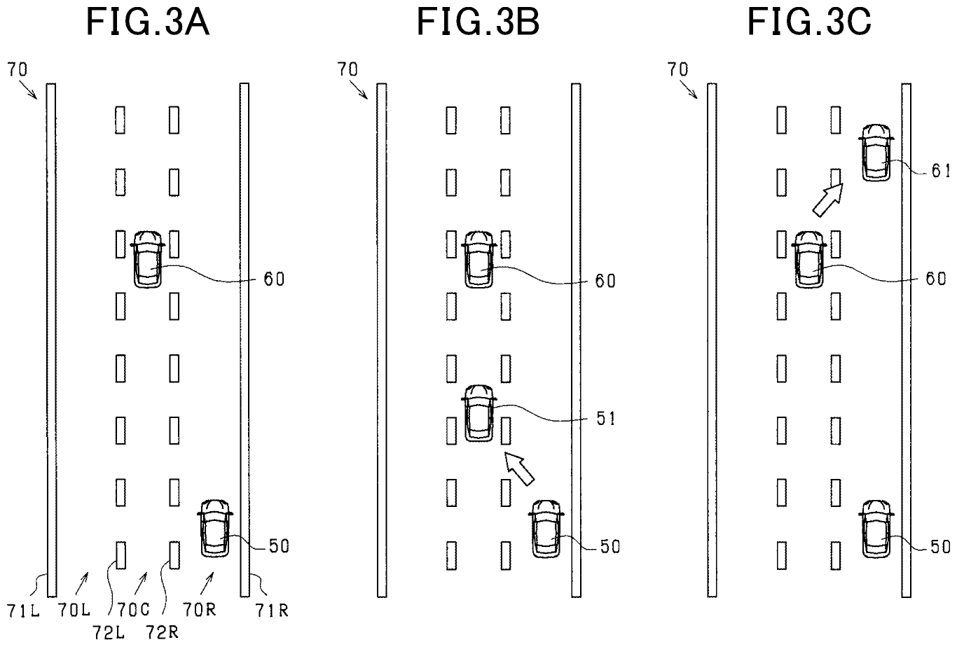

The following describes a specific operation in step S101 in an exemplary traffic situation illustrated in FIG. 3A.

The traffic situation illustrated in FIG. 3A shows a road 70 defined by left and right white solid lines 71L and 71R, and the road 70 is portioned by left and right dashed white lines 72L and 72R into three left, center, and right lanes 70L, 70C, and 70R. Reference character 50 represents the own vehicle that is traveling in the left lane 70L, and a preceding vehicle 60 is traveling in the center lane 70C ahead of the own vehicle 50. That is, the preceding vehicle 60 is detected in the front left side of the own vehicle 50 and no other vehicles are located between the own vehicle 50 and the adjacent preceding vehicle 60. Even if one or more other preceding vehicles are detected in front of the own vehicle 50, because the preceding vehicle 60 is the closest to the own vehicle in all the detected preceding vehicles, the preceding vehicle 60 is selected as the tracking-control target.

After completion of the operation in step S101, the vehicle control routine proceeds to step S102.

In step S102, the vehicle control apparatus 10 determined whether the tracking-control target is an adjacent preceding vehicle traveling in a lane adjacent to the own lane of the own vehicle. In response to determination that the tracking-control target is an adjacent preceding vehicle traveling in the lane adjacent to the own lane of the own vehicle (YES in step S102), the vehicle control routine proceeds to step S103. Otherwise, in response to determination that the tracking-control target is not an adjacent preceding vehicle traveling in the lane adjacent to the own lane of the own vehicle (NO in step S102), the vehicle control apparatus 10 terminates the vehicle control routine.

For example, if the preceding vehicle 60 illustrated in FIG. 3A is selected as the tracking-control target, because the preceding vehicle 60 is an adjacent preceding vehicle traveling in the adjacent lane, i.e., center lane 70C, adjacent to the own lane, i.e., the right lane 70R, the determination in step S102 is affirmative.

After affirmative determination in step S102, the vehicle control routine proceeds to step S103.

In step S103, the vehicle control apparatus 10 determines whether there is no prohibition against tracking control. In response to determination that there is no prohibition against tracking control (YES in step S103), the vehicle control routine proceeds to step S104. Otherwise, in response to determination that there is prohibition against tracking control (NO in step S103), the vehicle control apparatus 10 terminates the vehicle control routine.

In step S104, the vehicle control apparatus 10 determines whether an operated acceleration request for the own vehicle has been inputted thereto. In response to determination that an operated acceleration request for the own vehicle has been inputted to the vehicle control apparatus 10 (YES in step S104), the vehicle control routine proceeds to step S105. Otherwise, in response to determination that no operated acceleration request for the own vehicle has been inputted to the vehicle control apparatus 10, the vehicle control routine proceeds to step S106. In step S106, the vehicle control apparatus 10 performs the tracking control of the own vehicle with respect to the adjacent preceding vehicle selected as the tracking-control target, and thereafter terminates the vehicle control routine.

In step S105, the vehicle control apparatus 10 determines whether the adjacent preceding vehicle is likely to be changed as an own-lane preceding vehicle that will travel ahead of the own vehicle in the own lane.

The following describes a first specific operation in step S105 in an exemplary traffic situation illustrated in FIGS. 3A and 3B.

Let us assume that, as illustrated in FIG. 3A, the adjacent preceding vehicle 60 has been selected as the tracking-control target of the own vehicle 50. FIG. 3B illustrates a traffic situation where (i) it is recognized that the own vehicle 50 changes the own lane, i.e., the right lane 70R, to the adjacent lane, i.e., the center lane 70C, so as to be located at the rear side of the adjacent preceding vehicle 60 (see reference character 51) and (ii) no intention of lane change of the adjacent preceding vehicle has been recognized. In this traffic situation, the lane-changed own vehicle 51 and the adjacent preceding vehicle 60 are traveling in the same center lane 70C. This results in the adjacent preceding being changed to an own-lane preceding vehicle 60. For this reason, in the traffic situation illustrated in FIG. 3B, the vehicle control apparatus 10 determines that the adjacent preceding vehicle is likely to be changed as an own-lane preceding vehicle that will travel ahead of the own vehicle in the own lane in step S105.

The following describes a second specific operation in step S105 in an exemplary traffic situation illustrated in FIGS. 3A and 3C.

Let us assume that, as illustrated in FIG. 3A, the adjacent preceding vehicle 60 has been selected as the tracking-control target of the own vehicle 50. FIG. 3C illustrates a traffic situation where (i) it is recognized that the forward adjacent vehicle 60 changes the adjacent lane, i.e., center lane 70C, to the own lane, i.e., the right lane 70R, so as to be located in front of the own vehicle 50 and (ii) no intention of lane change of the own vehicle has been recognized. In this traffic situation, the lane-changed forward adjacent vehicle 60 and the own vehicle 50 are traveling in the same own lane 70C. This results in the adjacent preceding being changed to an own-lane preceding vehicle 60. For this reason, in the traffic situation illustrated in FIG. 3C, the vehicle control apparatus 10 determines that the adjacent preceding vehicle is likely to be changed as an own-lane preceding vehicle that will travel ahead of the own vehicle in the own lane in step S105.

That is, if the current traffic situation around the own vehicle matches the traffic situation illustrated in FIG. 3B or the traffic situation illustrated in FIG. 3C, the vehicle control routine proceeds to step S106. In step S106, the vehicle control apparatus 10 performs the tracking control of the own vehicle with respect to the adjacent preceding vehicle selected as the tracking-control target, and thereafter terminates the vehicle control routine.

Otherwise, if the current traffic situation around the own vehicle does not match each of the traffic situation illustrated in FIG. 3B and the traffic situation illustrated in FIG. 3C, the vehicle control apparatus 10 determines that the adjacent preceding vehicle 60 is unlikely to be changed as an own-lane preceding vehicle that will travel ahead of the own vehicle in the own lane (NO in step S105), resulting in the vehicle control routine proceeding to step S107.

In step S107, the vehicle control apparatus 10 terminates the tracking control of the own vehicle with respect to the adjacent preceding vehicle and prohibits the tracking control of the own vehicle. Thereafter, the vehicle control routine proceeds to step S108.

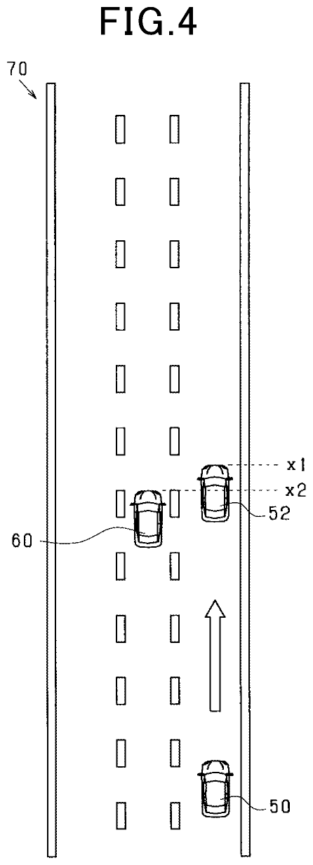

In step S108, the vehicle control apparatus 10 instructs the engine control unit 41 to accelerate the own vehicle based on the operated acceleration request for the own vehicle (see YES in step S104), resulting in the own vehicle passing one or more vehicles traveling in the adjacent lane. Termination of the tracking control of the own vehicle with respect to the adjacent preceding vehicle selected as the tracking-control target in step S102 enables, as illustrated in, for example, FIG. 4, the own vehicle to accelerate to accordingly pass the adjacent preceding vehicle; reference character 52 shows the own vehicle, which has passed the adjacent preceding vehicle.

The following describes, as an example, how the vehicle control apparatus 10 determines that the own vehicle 50 (52) has overtaken the adjacent preceding vehicle 60. Specifically, when the position of the front (see reference character x1) of the own vehicle 50 (52) is located ahead of the front (see reference character x2) of the adjacent preceding vehicle (see FIG. 4), the vehicle control apparatus 10 can determine that the own vehicle 50 (52) has overtaken the adjacent preceding vehicle 60.

Prohibition of the tracking control of the own vehicle with respect to the adjacent preceding vehicle selected as the tracking-control target in step S102 prohibits the own vehicle from being controlled to track one or more forward adjacent preceding vehicles traveling ahead of the adjacent preceding vehicle in the adjacent lane. This results in the own vehicle overtaking the one or more forward adjacent preceding vehicles traveling ahead of the adjacent preceding vehicle in the adjacent lane. After completion of the operation in step S108, the vehicle control routine proceeds to step S109.

In step S109, the vehicle control apparatus 10 determines whether a predetermined period t1 has elapsed since the own vehicle passed the adjacent preceding vehicle selected as the tracking-control target in step S102. The predetermined period t1 represents the first period, and the first period and the second period are, for example, set to be identical to each other in the vehicle control routine of FIG. 2.

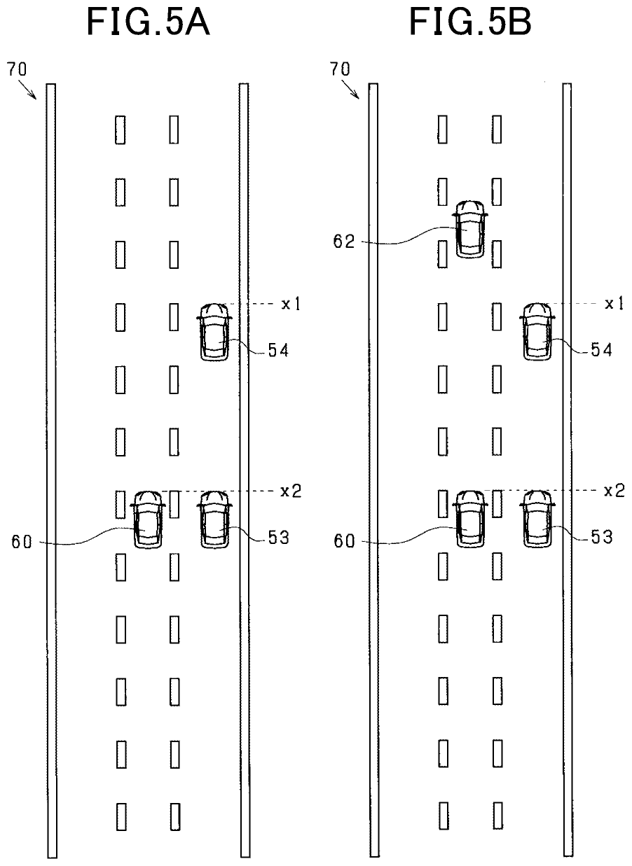

The following describes a specific operation in step S109 in an exemplary traffic situation illustrated in FIG. 5A.

In FIG. 5A, reference character 53 represents the location of the own vehicle whose position of the head has just passed the head x2 of the adjacent preceding vehicle 60. Additionally, reference character 54 represents that the location of the own vehicle after the period t1 has elapsed since the location 53 of the own vehicle. That is, the vehicle control apparatus 10 is programmed to iterate the determination in step S109 until the own vehicle has reached the location indicated by reference character 54, and the vehicle control routine proceeds to step S110 after the own vehicle has reached the location indicated by reference character 54.

Assuming that the tracking control of the own vehicle 50 with respect to the adjacent preceding vehicle 60 is terminated while the head x1 of the own vehicle 50 has just passed the head x2 of the adjacent preceding vehicle 60, which is illustrated in FIG. 4, the determination in step S109 prohibits the tracking control of the own vehicle 50 with respect to the adjacent preceding vehicle 60 and one or more forward adjacent preceding vehicles traveling ahead of the adjacent preceding vehicle 60 until the location of the own vehicle 50 is changed to the location indicated by the reference character 54 in FIG. 5A. In other words, even if one or more preceding vehicles are detected in front of or in the left or right front side of the own vehicle during the period required for the own vehicle 50 to have reached the location indicated by reference character 54, the determination in step S109 prohibits tracking control of the own vehicle 50 with respect to the detected one or more preceding vehicles.

This therefore eliminates the need of driver's repeated depressions of the accelerator pedal to pass the one or more preceding vehicles.

In step S110, the vehicle control apparatus 10 determines whether a forward adjacent preceding vehicle traveling ahead of the adjacent preceding vehicle has been detected before lapse of the period t1 since the own-vehicle's passing of the adjacent preceding vehicle.

As illustrated in FIG. 5A, when determining that no alternative forward preceding vehicles have been detected in front of or in the left or right front side of the own vehicle while the own vehicle has moved from the location indicated by reference character 53 to the location indicated by reference character 54, the vehicle control apparatus 10 cancels prohibition of the tracking control in step S111, and thereafter terminates the vehicle control routine.

In contrast, as illustrated in FIG. 5B, when determining that an alternative forward preceding vehicle 62 has been detected in front of or in the left or right front side of the own vehicle while the own vehicle has moved from the location indicated by reference character 53 to the location indicated by reference character 54, the vehicle control apparatus 10 returns to the operation in step S108, and iterates the operations in steps S108 to S110 until the determination in step S110 is negative. This enables the own vehicle to continue the state of efficiently passing the line of the adjacent preceding vehicle and one or more other vehicles in the adjacent lane until the own vehicle passes the line of the adjacent preceding vehicle and one or more other vehicles in the adjacent lane without driver's repeated depressions of the accelerator pedal.

The vehicle control apparatus 10 of the exemplary embodiment achieves the following excellent benefits.

Specifically, the vehicle control apparatus 10 is configured to perform acceleration/deceleration assistance for the own vehicle to accordingly perform the tracking control that causes the own vehicle to track a target preceding vehicle detected in front of the own vehicle or detected in the front left side or right side of the own vehicle.

In particular, the vehicle control apparatus 10 includes the travel-control target selector 13, the preceding-vehicle change determiner 14, the tracking prohibition determiner 15, and the instruction determiner 16.

The travel-control target selector 13 is configured to select a tracking-control target that is a target of the tracking control of the own vehicle.

The preceding-vehicle change determiner 14 is configured to determine whether the tracking-control target is an adjacent preceding vehicle that is traveling ahead of the own vehicle in a lane adjacent to the own lane of the own vehicle, and determine, in response to determination that the tracking-control target is the adjacent preceding vehicle that is traveling ahead of the own vehicle in the adjacent lane, whether the adjacent preceding vehicle is likely to be changed as an own-lane preceding vehicle that will travel ahead of the own vehicle in the own lane.

The instruction determiner 16 is configured to
(I) Calculate a target level of acceleration/deceleration of the own vehicle in accordance with determination of whether to perform the tracking control of the own vehicle with respect to the tracking-control target
(II) Determine, based on the calculated target level acceleration/deceleration of the own vehicle, one or more control instructions for the own vehicle

When determining that, with the adjacent preceding vehicle selected as the tracking-control target, (i) the operated acceleration request for the own vehicle has been inputted to the vehicle control apparatus 10 and (ii) the adjacent preceding vehicle is likely to be changed as an own-lane preceding vehicle, the vehicle control apparatus 10 is configured to determine to execute the tracking control of the own vehicle with respect to the adjacent preceding vehicle. Additionally, when determining that, with the adjacent preceding vehicle selected as the tracking-control target, (i) the operated acceleration request for the own vehicle has been inputted to the vehicle control apparatus 10 and (ii) the adjacent preceding vehicle is unlikely to be changed as an own-lane preceding vehicle, the vehicle control apparatus 10 is configured to terminate the tracking control of the own vehicle.

The above configuration of the vehicle control apparatus 10 performs the tracking control of the own vehicle with respect to the adjacent preceding vehicle in response to determination that the adjacent preceding vehicle is likely to be changed as an own-lane preceding vehicle. This configuration prevents the own vehicle from excessively approaching the own-lane preceding vehicle, making it possible to reliably ensure the safety of the own vehicle and the own-lane preceding vehicle.

The above configuration of the vehicle control apparatus 10 additionally terminates the tracking control of the own vehicle with respect to the adjacent preceding vehicle in response to determination that the adjacent preceding vehicle is unlikely to be changed as an own-lane preceding vehicle. This configuration enables the own vehicle to pass the adjacent preceding vehicle smoothly. That is, the vehicle control apparatus 10 of the exemplary embodiment makes it possible for the own vehicle to pass a preceding vehicle traveling in the adjacent lane smoothly.

The vehicle control apparatus 10 further includes the tracking prohibition determiner 15.

When determining that the operated acceleration request for the own vehicle has been inputted to the vehicle control apparatus 10 with the adjacent preceding vehicle selected as the tracking-control target, the tracking prohibition determiner 15 is configured to terminate the tracking control of the own vehicle with respect to the adjacent preceding vehicle.

Additionally, the tracking prohibition determiner 15 is configured to determine to have prohibited the tracking control of the own vehicle with respect to any vehicle traveling in the adjacent lane for the predetermined first period since the own vehicle passed the adjacent preceding vehicle.

Even if the adjacent preceding vehicle and one or more other vehicles ahead of the adjacent preceding vehicle are traveling in a line on the lane adjacent to the own lane, the tracking prohibition determiner 15 has prohibited the tracking control of the own vehicle with respect to the one or more other vehicles traveling ahead of the adjacent preceding vehicle in the adjacent lane for the predetermined first period since the own vehicle passed the adjacent preceding vehicle. This determination avoids the own vehicle from tracking the one or more other vehicles traveling ahead of the adjacent preceding vehicle until the first period has elapsed since the own-vehicle's passing the adjacent preceding vehicle, making it possible to enable the own vehicle to pass the line of the adjacent preceding vehicle and the one or more other vehicles efficiently. That is, the vehicle control apparatus 10 of the exemplary embodiment makes it possible for the own vehicle to pass one or more vehicles traveling in the adjacent lane smoothly.

When determining that a forward adjacent preceding vehicle traveling ahead of the adjacent preceding vehicle has been detected before lapse of the first period since the own-vehicle's passing the adjacent preceding vehicle, the tracking prohibition determiner 15 can be configured to continue prohibition of the tracking control of the own vehicle with respect to any vehicle traveling in the adjacent lane for the predetermined second period since the own vehicle passed the detected forward adjacent preceding vehicle. This determination enables the own vehicle to continue the state of efficiently passing the line of the adjacent preceding vehicle and the forward adjacent preceding vehicle traveling in the adjacent lane until the own vehicle passes the line of the adjacent preceding vehicle and the forward adjacent preceding vehicle without repeat of an accelerator-pedal operation.

The control apparatuses and their control methods executable by the control apparatuses in the present disclosure can be implemented by a dedicated computer including a memory and a processor programmed to perform one or more functions embodied by one or more computer programs.

The control apparatuses and their control methods executable by the control apparatuses in the present disclosure can also be implemented by a dedicated computer including a processor comprised of one or more dedicated hardware logic circuits.

The control apparatuses and their control methods executable by the control apparatuses in the present disclosure can further be implemented by a processor system comprised of a memory, a processor programmed to perform one or more functions embodied by one or more computer programs, and one or more hardware logic circuits.

The one or more programs can be stored in a computer-readable non-transitory storage medium as instructions to be carried out by a computer or a processor.

While the illustrative embodiments of the present disclosure have been described herein, the present disclosure is not limited to the embodiments and their modifications described herein, but includes any and all embodiments having modifications, omissions, combinations (e.g., of aspects across various embodiments), adaptations and/or alterations as would be appreciated by those in the art based on the present disclosure within the scope of the present disclosure.

1. A vehicle control apparatus for performing acceleration/deceleration assistance for an own vehicle traveling in an own lane to accordingly perform tracking control that causes the own vehicle to track a preceding vehicle detected in front of the own vehicle or detected to a front left side or front right side of the own vehicle, the vehicle control apparatus comprising:
a travel-control target selector configured to select a tracking-control target that is a target of the tracking control;
a preceding-vehicle change determiner configured to:
determine whether the tracking-control target is an adjacent preceding vehicle that is traveling ahead of the own vehicle in a lane adjacent to the own lane of the own vehicle;
determine, in response to determination that the tracking-control target is the adjacent preceding vehicle that is traveling ahead of the own vehicle in the adjacent lane, whether the adjacent preceding vehicle is likely to be changed as an own-lane preceding vehicle that will travel ahead of the own vehicle in the own lane; and
an instruction determiner configured to:
calculate a target level of acceleration/deceleration of the own vehicle in accordance with determination of whether to perform the tracking control of the own vehicle with respect to the tracking-control target; and
determine, based on the calculated target level acceleration/deceleration of the own vehicle, one or more control instructions for the own vehicle,
when determining that, with the adjacent preceding vehicle selected as the tracking-control target and an operated acceleration request for the own vehicle having been inputted to the vehicle control apparatus, the adjacent preceding vehicle is likely to be changed as an own-lane preceding vehicle, the vehicle control apparatus being configured to perform the tracking control of the own vehicle with respect to the adjacent preceding vehicle,
when determining that, with the adjacent preceding vehicle selected as the tracking-control target, (i) the operated acceleration request for the own vehicle has been inputted to the vehicle control apparatus and (ii) the adjacent preceding vehicle is unlikely to be changed as an own-lane preceding vehicle, the vehicle control apparatus being configured to terminate the tracking control of the own vehicle.

2. A vehicle control apparatus for performing acceleration/deceleration assistance for an own vehicle traveling in an own lane to accordingly perform tracking control that causes the own vehicle to track a preceding vehicle detected in front of the own vehicle or detected to a front left side or front right side of the own vehicle, the vehicle control apparatus comprising:
a travel-control target selector configured to select a tracking-control target that is a target of the tracking control;
a tracking prohibition determiner configured to:
terminate, when determining that an operated acceleration request for the own vehicle has been inputted to the vehicle control apparatus with the adjacent preceding vehicle selected as the tracking-control target, the tracking control of the own vehicle with respect to the adjacent preceding vehicle;
determine whether a predetermined first period has elapsed since the own vehicle passed the adjacent preceding vehicle; and
prohibit the tracking control of the own vehicle with respect to any vehicle traveling in the adjacent lane until it is determined that the predetermined first period has elapsed since the own vehicle passed the adjacent preceding vehicle; and
an instruction determiner configured to:
calculate a target level of acceleration/deceleration of the own vehicle in accordance with determination of whether to perform the tracking control of the own vehicle with respect to the tracking-control target; and
determine, based on the calculated target level acceleration/deceleration of the own vehicle, one or more control instructions for the own vehicle.

3. The vehicle control apparatus according to claim 2, wherein:
the tracking prohibition determiner is configured to, when determining that a forward adjacent preceding vehicle traveling ahead of the adjacent preceding vehicle has been detected before lapse of the first period since the own vehicle passed the adjacent preceding vehicle, continue prohibition of the tracking control of the own vehicle with respect to any vehicle traveling in the adjacent lane until it is determined that a predetermined second period has elapsed since the own vehicle passed the adjacent preceding vehicle.
